(19) United States
(12) Patent Application Publication
(10) Pub. No.: US 2022/0237203 A1
(43) Pub. Date: Jul. 28, 2022

(54) METHOD AND SYSTEM FOR EFFICIENTLY PROPAGATING OBJECTS ACROSS A FEDERATED DATACENTER

(71) Applicant: VMware, Inc., Palo Alto, CA (US)

(72) Inventors: Sambit Kumar Das, Hayward, CA (US); Anand Parthasarathy, Fremont, CA (US); Shyam Sundar Govindaraj, Santa Clara, CA (US)

(21) Appl. No.: 17/568,819

(22) Filed: Jan. 5, 2022

Related U.S. Application Data
(60) Provisional application No. 63/140,769, filed on Jan. 22, 2021.

(51) Int. Cl. G06F 16/25; G06F 16/27; H04L 9/40

(52) U.S. Cl. CPC G06F 16/256; H04L 63/0853; G06F 16/27

(57) ABSTRACT

Some embodiments of the invention provide a method for providing resiliency for globally distributed applications that span a federation that includes multiple geographically dispersed sites. At a first site, the method receives, from a second site, a login request for accessing a federated datastore maintained at the first site. The first site determines that the second site should be authorized and provides an authorization token to the second site, the authorization token identifying the second site as an authorized site. Based on the authorization token, the first site replicates a set of data from the federated datastore to the second site.

### BACKGROUND

Today, applications can be deployed across multiple geographically dispersed sites (regions) to provide better availability as well as for latency and failover needs. In order to keep operations simple and to keep configurations consistent across these sites, customers often use a federation of clusters. However, these large-scale systems are often crippled by network partitions or maintenance failure-based site unavailability during configuration of the federation as well as at-scale state replication. Furthermore, the onus of replication in these systems often rests on the federation leader, which maintains a per-site replication queue. As a result, the scale of such systems are limited as the number of sites and federated objects increase simultaneously.

### BRIEF SUMMARY

Some embodiments of the invention provide a method for providing resiliency for globally distributed applications (e.g., DNS (domain name server) applications in a global server load balancing (GSLB) deployment) that span a federation of multiple geographically dispersed sites. At a first site, the method receives, from a second site, a login request for accessing a federated datastore maintained at the first site. The method determines that the second site should be authorized and provides an authorization token to the second site that identifies the second site as an authorized site. Based on the authorization token, the first site replicates a set of data from the federated datastore to the second site.

In some embodiments, after replicating the set of data to the second site, the first site receives a confirmation notification from the second site indicating that the replicated set of data has been consumed by the second site. Alternatively, of conjunctively, the first site in some embodiments detects a connection error with the second site before the entire set of data has been replicated to the second site. In some such embodiments, the first site waits for the connection error to resolve, and, once the second site has reconnected, determines a subset of the data that still needs to be replicated to the second site, and replicates this subset of data. The connection error, in some embodiments, can be due to a service interruption or a network partition, or may be a connection loss resulting from scheduled maintenance at the second site.

The first site, in some embodiments, is a leader first site while the second site is a client second site of multiple client sites. In some embodiments, each client site includes a watcher agent that corresponds to one of multiple watcher agents at the leader site. The watcher agents at the leader site, in some embodiments, maintain connectivity with the federated datastore and monitor it for any updates to the federation (e.g., updates to objects or other configuration data). This client-server implementation, in some embodiments, allows the capabilities of the federated datastore to be extended across the entire federation.

In some embodiments, the leader site watcher agents are configured to perform continuous replication to their respective client site watcher agents such any detected updates are automatically replicated to the client sites. This implementation ensures that all active client sites in the federation maintain up-to-date versions of the configuration, according to some embodiments. A proxy engine (e.g., NGINX, Envoy, etc.) at the leader site enables the use of bidirectional gRPC (open source remote procedure call) streaming between the watcher agents at the leader site and the watcher agents at the client sites, according to some embodiments. In some embodiments, the proxy engine is used to avoid exposing internal ports to the rest of the federation.

In some embodiments, each of the client sites also includes an API server with which the client site watcher agents interface. The client site watcher agents, in some embodiments, are configured to watch for updates from their corresponding leader site watcher agents. When a client site watcher agent receives a stream of data (e.g., updates to the configuration) from its corresponding leader site watcher agent, the data is passed to the client site's API server, which then persists the data into a database at the client site, according to some embodiments. The client site watcher agent then resumes listening for updates.

In addition to the continuous replication described above, some embodiments provide an option to users (e.g., network administrators) to perform manual replication. Manual replication gives users full control over when replications are done, according to some embodiments. In some embodiments, users can perform a phased rollout of an application across the various sites. For example, in some embodiments, users can configure CUDs (create, update, destroy) on the leader site, verify the application on the leader site, create a configuration checkpoint on the leader site, and view pending objects (e.g., policies). In some embodiments, the application is rolled out to the client sites one site at a time (e.g., using a canary deployment).

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, the Detailed Description, the Drawings, and the Claims is needed. Moreover, the claimed subject matters are not to be limited by the illustrative details in the Summary, the Detailed Description, and the Drawings.

### BRIEF DESCRIPTION OF FIGURES

The novel features of the invention are set forth in the appended claims. However, for purposes of explanation, several embodiments of the invention are set forth in the following figures.

FIG. 1 conceptually illustrates an example federation that includes a leader site and multiple client sites, according to some embodiments.

FIG. 2 conceptually illustrates a process performed by a client site to join a federation, according to some embodiments.

FIG. 3 conceptually illustrates a more in-depth look at a leader site and a client site in a federation, according to some embodiments.

FIG. 4 conceptually illustrates a process performed by a leader site when a client site requests to join the federation, according to some embodiments.

FIG. 5 conceptually illustrates a process performed by a leader site watcher agent that monitors the federated datastore for updates, according to some embodiments.

FIG. 6 conceptually illustrates a state diagram for a finite state machine (FSM) of a watcher agent, in some embodiments.

FIG. 7 conceptually illustrates an example federation in which client sites share state, according to some embodiments.

FIG. 8 illustrates a GSLB system that uses the sharding method of some embodiments.

FIG. 9 illustrates a more detailed example of a GSLB system that uses the sharding method of some embodiments of the invention.

FIG. 10 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide a method for providing resiliency for globally distributed applications (e.g., DNS applications in a GSLB deployment) that span a federation of multiple geographically dispersed sites. At a first site, the method receives, from a second site, a login request for accessing a federated datastore maintained at the first site. The method determines that the second site should be authorized and provides an authorization token to the second site that identifies the second site as an authorized site. Based on the authorization token, the first site replicates a set of data from the federated datastore to the second site.

In some embodiments, after replicating the set of data to the second site, the first site receives a confirmation notification from the second site indicating that the replicated set of data has been consumed by the second site. Alternatively, or conjunctively, the first site in some embodiments detects a connection error with the second site before the entire set of data has been replicated to the second site. In some such embodiments, the first site waits for the connection error to resolve, and, once the second site has reconnected, determines a subset of the data that still needs to be replicated to the second site, and replicates this subset of data. The connection error, in some embodiments, can be due to a service interruption or a network partition, or may be a connection loss resulting from scheduled maintenance at the second site.

The first site, in some embodiments, is a leader first site while the second site is a client second site of multiple client sites. In some embodiments, each client site includes a watcher agent that corresponds to one of multiple watcher agents at the leader site. The watcher agents at the leader site, in some embodiments, maintain connectivity with the federated datastore and monitor it for any updates to the federation (e.g., updates to objects or other configuration data). This client-server implementation, in some embodiments, allows the capabilities of the federated datastore to be extended across the entire federation.

In some embodiments, the leader site watcher agents are configured to perform continuous replication to their respective client site watcher agents such any detected updates are automatically replicated to the client sites. This implementation ensures that all active client sites in the federation maintain up-to-date versions of the configuration, according to some embodiments. A proxy engine (e.g., NGINX, Envoy, etc.) at the leader site enables the use of bidirectional gRPC streaming between the watcher agents at the leader site and the watcher agents at the client sites, according to some embodiments. In some embodiments, the proxy engine is used to avoid exposing internal ports to the rest of the federation.

In some embodiments, each of the client sites also includes an API server with which the client site watcher agents interface. The client site watcher agents, in some embodiments, are configured to watch for updates from their corresponding leader site watcher agents. When a client site watcher agent receives a stream of data (e.g., updates to the configuration) from its corresponding leader site watcher agent, the data is passed to the client site's API server, which then persists the data into a database at the client site, according to some embodiments. The client site watcher agent then resumes listening for updates.

In addition to the continuous replication described above, some embodiments provide an option to users (e.g., network administrators) to perform manual replication. Manual replication gives users full control over when replications are done, according to some embodiments. In some embodiments, users can perform a phased rollout of an application across the various sites (i.e., using a canary deployment). For example, in some embodiments, users can configure CUDs on the leader site, verify the application on the leader site, create a configuration checkpoint on the leader site, and view pending objects (e.g., policies, templates, etc.).

The checkpoints, in some embodiments, annotate the configuration at any given point in time and preserve FederatedDiff version in Object Runtime. In some embodiments, the checkpoints can manually be marked as active when a configuration passes necessary rollout criteria on the leader site, and can be used to ensure that client sites cannot go past a particular checkpoint. Additionally, manual replication mode enables additional replication operations. For example, users can fast forward to active checkpoints and replicate the delta configuration until the checkpoint version. In another example, users can force sync to an active checkpoint, such as when a fault configuration was rectified on the leader, and replicate the full configuration at the checkpoint version.

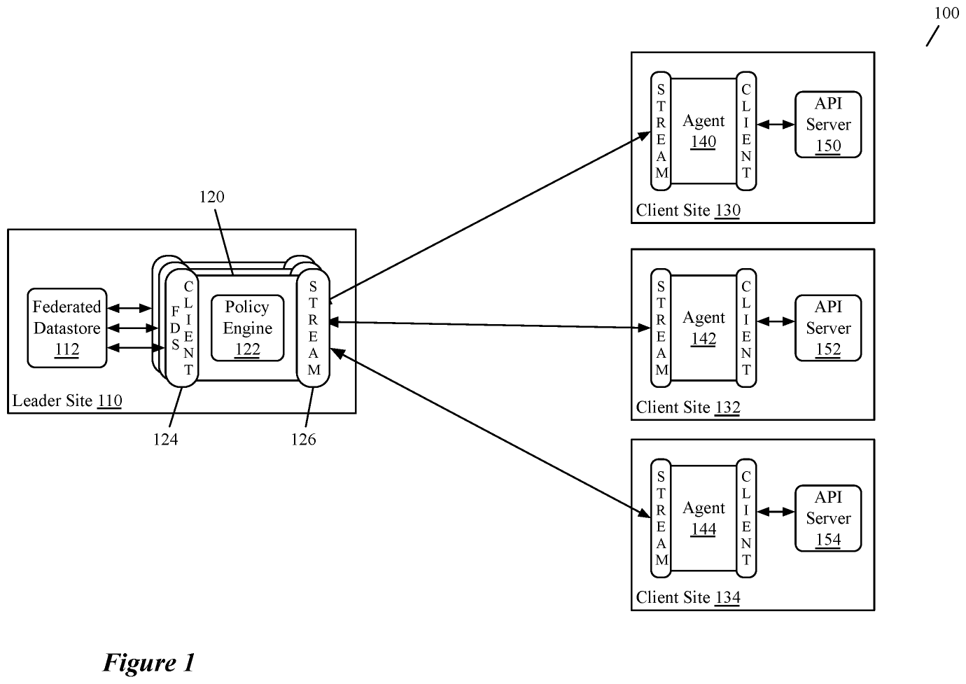

FIG. 1 illustrates simplified example of a federation 100 in which a DNS application may be deployed, according to some embodiments. As shown, the federation 100 includes a leader site 110 and multiple client sites 130-134 (also referred to herein as follower sites). A federation, in some embodiments, includes a collection of sites that are both commonly managed and separately managed such that one area of the federation can continue to function even if another area of the federation fails. In some embodiments, applications (e.g., a DNS application) in the federation are implemented in a GSLB deployment (e.g., NSX Advanced Load Balancer), and each client site represents a client site that hosts the DNS application (i.e., hosts a DNS server).

As shown, the leader site 110 includes a federated datastore 112 and multiple leader site watcher agents 120 (also referred to herein as “agents”). The leader site watcher agents 120 each include a policy engine 122 to control interactions with the federated datastore 112, a client interface 124 with the federated datastore 112, and a stream 126 facing the client sites.

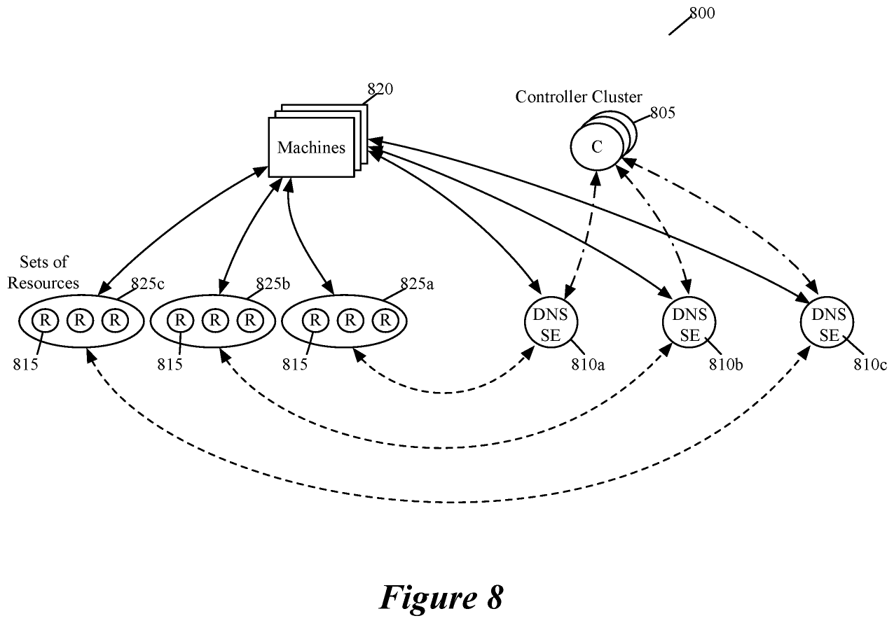

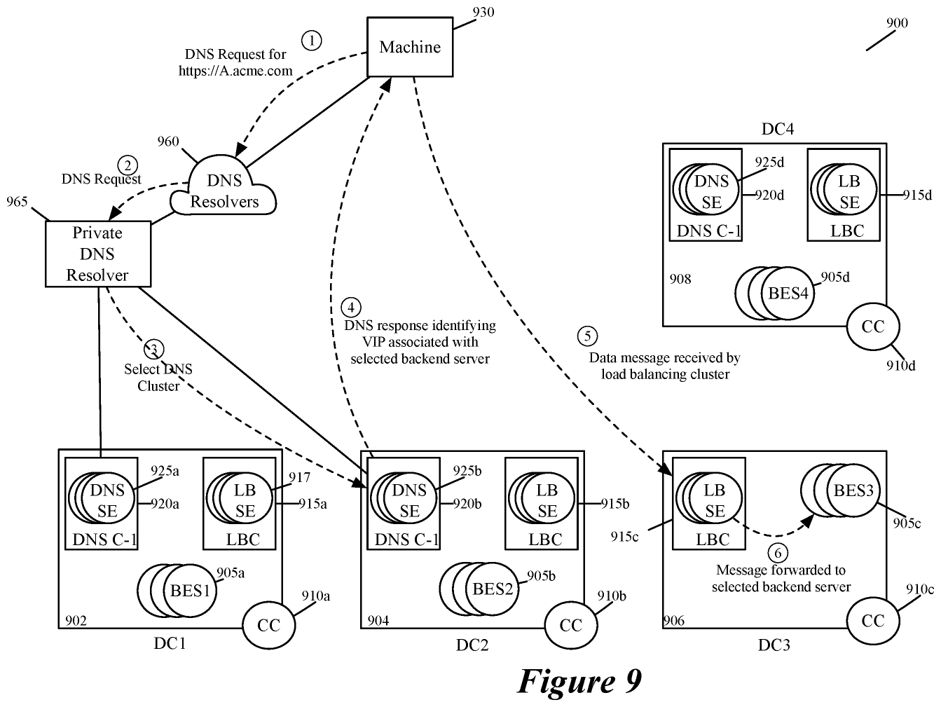

Each of the leader site agents 120 maintains connectivity with the federated datastore 112 in order to watch for (i.e., listen for) updates and changes to the configuration, according to some embodiments. The federated datastore 112, in some embodiments, is used as an in-memory referential object store that is built on an efficient version-based storage mechanism (e.g., etcd). The federated datastore 112 in some embodiments monitors all configuration updates and maintains diff queues as write-ahead logs in persistent storage in the same order in which transactions are committed. In some embodiments, the objects stored in the federated datastore 112 include health monitoring records collected at each of the client sites. Additional details regarding health monitoring will be described below with reference to FIGS. 8 and 9.

In some embodiments, upon bootup, the federated datastore loads all objects onto its own internal object store at a particular version and listens to the diff queue and applies any diffs as they arise. When a diff is applied, in some embodiments, it locks the entire datastore and updates the object and version. Doing so guarantees that whenever anything reads the datastore, a totally consistent view is shown. The federated datastore maintains the latest version of the configuration in-memory and uses the diff queues to reconstruct older versions of objects in the configuration upon request, according to some embodiments. In some embodiments, the size of the diff queue maintained by the federated datastore determines the furthest versioned object that can be recreated. As a result, the size of the diff queue in some embodiments is limited to, e.g., 1 million records or 1 day of records, depending on which is reached first.

The client sites 130-134 each include a client site watcher agent 140-144 and an API server 150-154 with which each of the client site agents interface. Additionally, like the leader site counterparts, the client site agents 140-144 each includes a stream interface facing the leader site. The API servers 150-154, in some embodiments, receive configuration data and other information from the client site watcher agents 140-144 and persist the data to a database (not shown) at their respective client site.

The leader site and client site agents, in some embodiments, are generic infrastructure that support any client and glue themselves to a stream (e.g., stream 126) facing the other site to exchange messages. In some embodiments, the client site agents are responsible for initiating streams and driving the configuration process, thereby significantly lightening the load on the leader site and allowing for scalability. Additionally, the client-server implementation of the agents enables the capabilities of the federated datastore 112 to be extended across the entire federation 100. In some embodiments, as will be described further below, a proxy is installed on the leader side (server side) to avoid exposing internal ports on the leader side to the rest of the federation and to allow the agents on at the leader site to exchange gRPC messages with the agents at each of the client sites. In addition to exchanging gRPC messages, the agents in some embodiments are also configured to perform health status monitoring of their corresponding agents.

The agents 120 and 140-144 additionally act as gatekeepers of gRPC streams that connect the different sites and further present a reliable transport mechanism to stream versioned objects from the federated datastore 112. The transport, in some embodiments, also implements an ACK mechanism for the leader site to gain insight into the state of the configuration across the federation. For example, in some embodiments, if an object could not be replicated on a client site, the lack of replication would be conveyed to the leader site via an ACK message. gRPC interfaces exposed by the framework described above are as follows:

rpc Watch (stream {req_version, ACK msg})

returns (stream {version, Operation, Object});

rpc Sync (stream {req_version, ACK msg})

returns (stream {version, Operation, Object}).

In order to join the federation, the client sites in some embodiments must first be authenticated by the leader site. The authentication is initiated by the client upon invoking a login API using credentials received by the client site during an out-of-band site invitation process, according to some embodiments. The leader site in some embodiments validates that the client site is a registered site by ensuring that the client IP (Internet Protocol) is part of the federation. In some embodiments, if authentication is successful, the leader site issues a JSON Web Token (JWT), which includes a client site UUID signed using a public private key pair using the public key crypto-system RSA. The client site then passes this JWT in every subsequent gRPC context header to allow StreamInterceptors and UnaryInterceptors to perform validations, according to some embodiments.

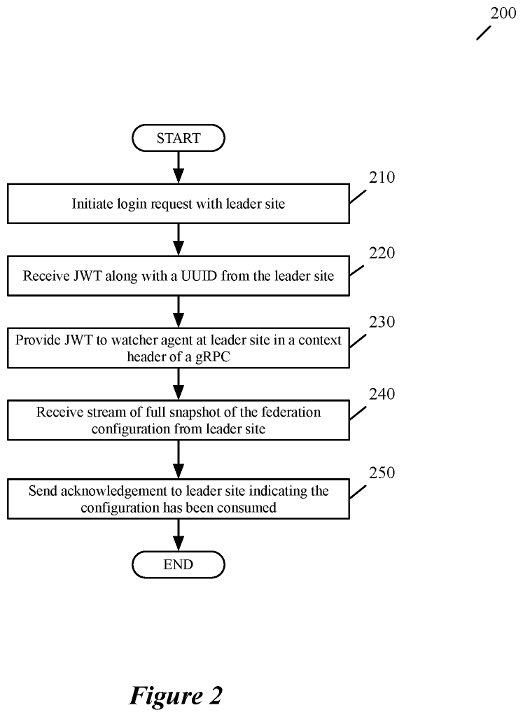

FIG. 2 illustrates a process in some embodiments performed by a client site watcher agent to join the federation. As shown, the process 200 starts at 210 by initiating a login request with the leader site (e.g., leader site 110). In some embodiments, initiating a login request to the leader site includes invoking a login API using credentials received during an out-of-band site invitation process (e.g., “/api/login?site_jwt”). The client site watcher agent in some embodiments provides this login API to a portal at the leader site that is responsible for processing such requests.

Next, the process receives (at 220) a notification of authentication from the leader site (e.g., from the portal at the leader site to which the login API was sent). In some embodiments, the notification includes a JWT that includes a UUID for the client site, as described above, which the client site passes in context headers of gRPC messages for validation purposes. In cases where credentials have changed or other site-level triggers are experienced, the leader site in some embodiments revokes the JWT by terminating existing sessions, thus forcing the client site to re-authenticate with the leader site.

After receiving the notification of authentication at 220, the process provides (at 230) the received JWT to a corresponding leader site watcher agent. As noted above, the JWT is passed by the client site in gRPC context headers to allow interceptors to validate the client site. In some embodiments, the JWT is passed by the client site to the leader site in an RPC sync message that requests a stream of a full snapshot of the entire configuration of the federation. The process then receives (at 240) a stream of data replicated from the federated datastore.

Once all of the data has been received at the client site and persisted into storage, the process sends a notification (at 250) to the leader site to indicate that all of the streamed data has been consumed at the client site. The process then ends. Some embodiments perform the process 200 when a new client site has been invited into the federation and requires a full sync of the federation's configuration. Alternatively, or conjunctively, some embodiments perform this full sync when a client site has to re-authenticate with the leader site (e.g., following a change in credentials). In either instance, it is up to the client site to initiate and invoke the synchronization with the leader site, according to some embodiments.

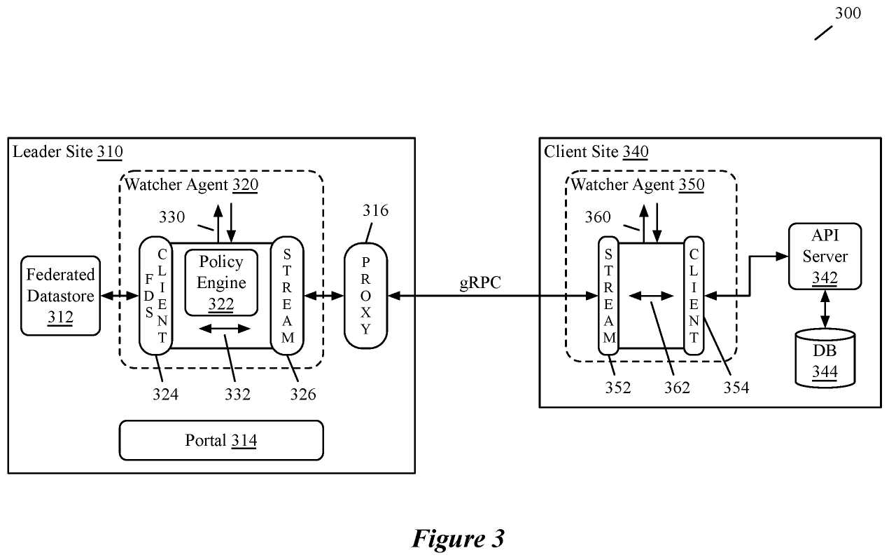

FIG. 3 illustrates a more in-depth view of a leader site and a client site in a federation, according to some embodiments. The federation 300 includes a leader site 310 and a client site 340, as shown. The leader site 310 includes a federated datastore 312, a portal 314, a proxy 316, and a watcher agent 320. As described above, the federated datastore 312 is an in-memory referential object store that is built on an efficient version-based storage mechanism, according to some embodiments.

The portal 314 on the leader site 310, in some embodiments, is the mechanism responsible for receiving and processing the login requests from the client sites and issuing the JWTs in response. When a client site has gone through the out-of-band invitation process, the client site can then send the login request (e.g., login API) to the portal 314 at the leader site to request authentication. Upon determining that the client site should be authenticated, the portal 314 issues the JWT to the requesting client site, according to some embodiments.

In some embodiments, as mentioned above, the leader site includes a proxy 316 (e.g., NGINX, Envoy, etc.) for enabling gRPC streaming between the leader site watcher agent 320 and the client site watcher agent 350. The proxy 316 also eliminates the need to expose or open additional ports between sites, according to some embodiments.

The leader site watcher agent 320 includes a policy engine 322, a federated datastore interface 324 for interfacing with the federated datastore 312, a client site-facing stream interface 326, a control channel 330 for carrying events, and a data channel 332 for carrying data. The policy engine 322, like the policy engine 122, controls interactions with the federated datastore 312. Additionally, the policy engine 322 is configured to stall erroneous configurations from being replicated to the rest of the configuration, according to some embodiments. In some embodiments, when data from the federated datastore is to be replicated to the client site 340, the leader site watcher agent 320 interfaces with the federated datastore 312 via the federated datastore interface 324 and uses the data channel 332 to pass the data to the stream interface 326, at which time the data is then replicated to the client site watcher agent 350 via the proxy 316.

The client site 340 includes a watcher agent 350, an API server 342, and a database 344. The client site watcher agent 350 includes a stream interface 352, a client interface 354, a control channel 360, and a data channel 362. Like the control channel 330 and the data channel 332, the control channel 360 carries events, while the data channel 362 carries data. When the leader site watcher agent 320 streams data to the client site 340, it is received through the stream interface 352 of the client site watcher agent 350, passed by the data channel 362 to the client interface 354, and provided to the API server 342, according to some embodiments. The API server 342 then consumes the data, persists it to the database 344, and also sends an acknowledgement message back to the leader site along with a consumed version number, in some embodiments.

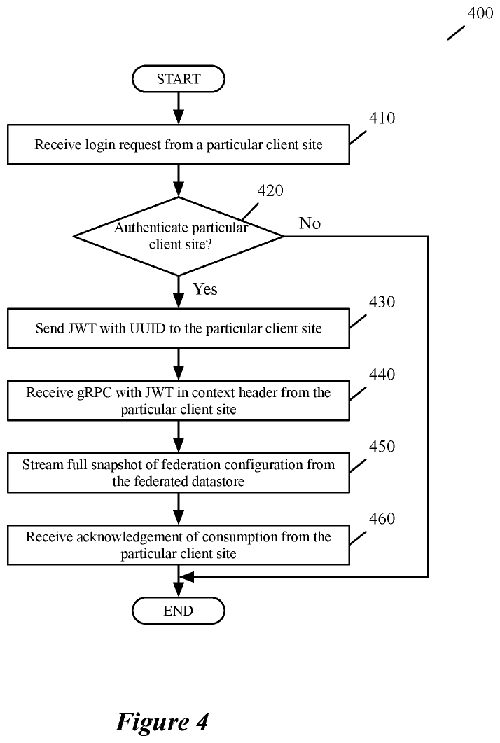

FIG. 4 illustrates a process performed by the leader site when a client site is being added (or re-added) to the configuration in some embodiments. The process 400 will be described with reference to the federation 300. As shown, the process 400 starts (at 410) by receiving a login request from a particular client site. The login request, in some embodiments, can be a login API that uses credentials received by the particular client site during an out-of-band site invitation process, and may be received by a portal (e.g., portal 314) at the leader site that is responsible for processing such login requests.

At 420, the process determines whether to authenticate the particular client site. For example, if the portal at the leader site receives a login request from a client site that has not yet received any credentials or taken part in an invitation process, the portal may not authenticate the client site. When the process determines at 420 that the particular client site should not be authenticated, the process ends. Otherwise, when the process determines at 420 that the particular client site should be authenticated, the process transitions to 430 to send an authentication notification to the particular client site. As described for the process 200, the authentication notification in some embodiments includes a JWT with a UUID for the client site.

Next, at 440, the process receives from the particular client site a gRPC message with a context header that includes the JWT for the particular client site. The gRPC message in some embodiments is an RPC sync message, as described above with reference to process 200. In other embodiments, the gRPC message is an RPC watch message to request updates to one or more portions of the configuration starting from a specific version. Additional examples regarding the use of RPC watch messages will be described further below.

In response to receiving the gRPC message from the particular client site, the process next streams (at 450) a full snapshot of the current configuration of the federation, replicated from the federated datastore. Alternatively, or conjunctively, such as when the gRPC message is an RPC watch message, only a portion of the configuration is replicated and streamed to the requesting client site. Next, the process receives (at 460) confirmation from the particular client site that the configuration has been consumed (i.e., received, processed, and persisted to a database) by the particular client site. The process 400 then ends.

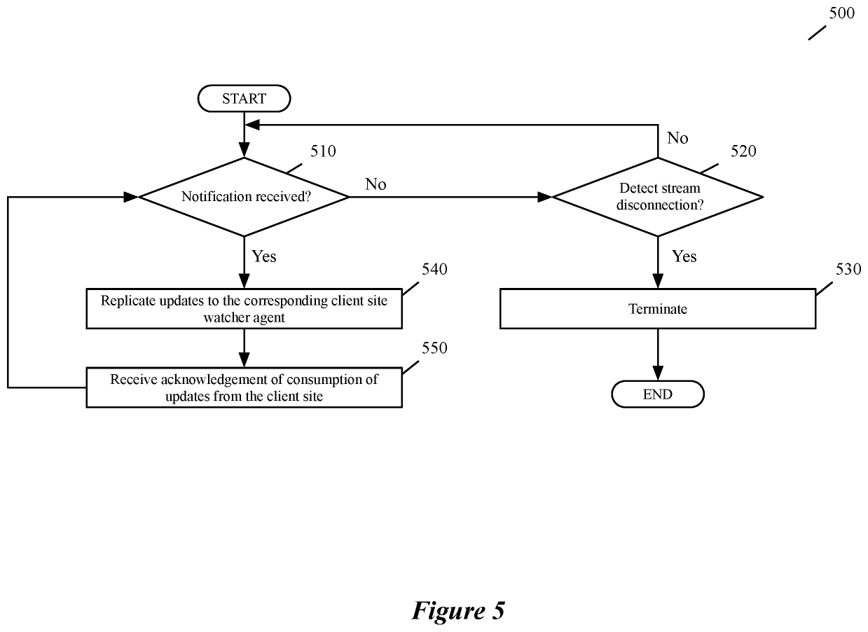

FIG. 5 illustrates a process performed by a leader site watcher agent, according to some embodiments. The process 500 starts at 510 by determining whether a notification has been received from the federated datastore indicating changes (e.g., updates) to the federated datastore. For example, the leader site watcher agent 320 can receive notifications from the federated datastore 312 in the example federation 300 described above.

When the leader site watcher agent determines that no notifications have been received, the process transitions to 520 to detect whether the stream to the client site has been disconnected. When the leader site watcher agent determines that the stream to the client site has been disconnected, the process transitions to 530 to terminate the leader site watcher agent. In some embodiments, the leader site watcher agent is automatically terminated when its corresponding client site becomes disconnected. Following 530, the process ends.

Alternatively, when the leader site watcher agent determines at 520 that the stream to the client site is not disconnected, the process returns to 510 to determine whether a notification has been received from the federated datastore. When the leader site agent determines at 510 that a notification has been received from the federated datastore indicating changes (e.g., updates) to the federated datastore, the process transitions to 540 to replicate the updates to the corresponding client site watcher agent (i.e., via the stream interfaces 326 and 352 of the watcher agents at the leader and client sites and the proxy 316).

After replicating the updates to the corresponding client site watcher agent at 540, the leader site watcher agent receives, at 550, acknowledgement of consumption of the replicated updates from the client site. As mentioned above, the API server at the client site (e.g., API server 342) is responsible for sending an acknowledgement message to the leader site once the updates have been consumed. Following receipt of the acknowledgement of consumption at 550, the process returns to 510 to determine whether a notification has been received from the federated datastore.

In some embodiments, when a client site loses connection with the leader site, the client site is responsible for re-establishing the connection and requesting the replicated configuration from the last saved version number. In some such embodiments, the corresponding leader site watcher agent is terminated, and a new leader site watcher agent for the client site is created when the client site re-establishes the connection. In some embodiments, the client site must first retrieve a new JWT from the leader site via another login request. In other words, the configuration process in some embodiments is both initiated and driven by the client sites, thus accomplishing the goal of keeping the load on the leader site light to allow for scalability.

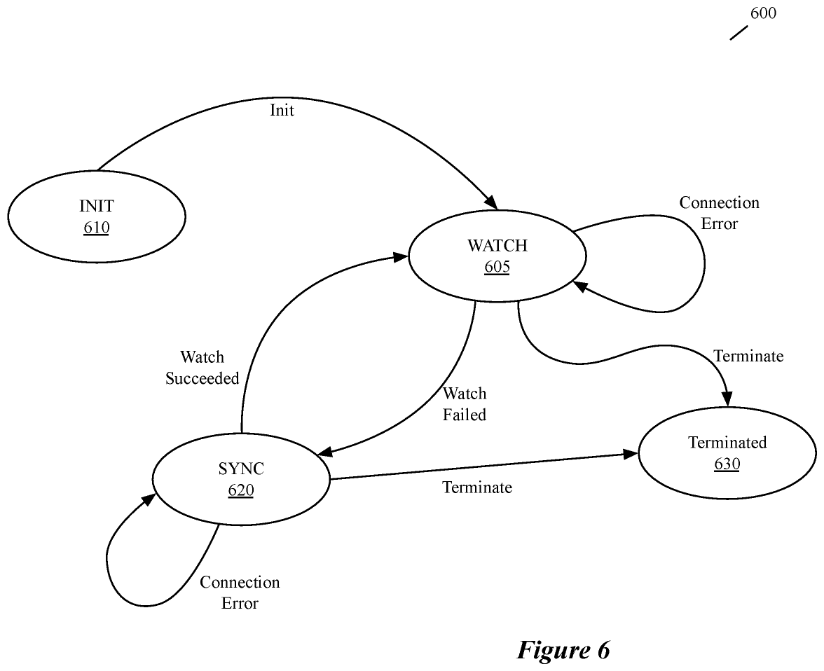

In some embodiments, the client site watcher agents are also responsible for driving the finite state machine (FSM), which is responsible for transitioning between different gRPC based on certain triggers. FIG. 6 illustrates a state diagram 600 representing the different states a client-side FSM transitions between based on said triggers, according to some embodiments.

The first state of the FSM is the initialization state 610. Once the FSM is initialized, it transitions to the watch state 605. In some embodiments, the watch state 605 is the normal state for the FSM to be in. While the FSM is in the watch state 605, the client site watcher agent watches for updates from its corresponding leader site watcher agent by initiating a Watch gRPC to request any configuration updates from the federated datastore (i.e., through the leader site watcher agent and its policy engine as described above) starting from a given version. In some embodiments, if the requested version is older than a minimum version in a diff queue table maintained by the federated datastore, the gRPC will be rejected as it is too far back in time. Alternatively, in some such embodiments, if the requested version is recent enough, the diff queue is used to identify a list of objects that have changes, and these objects are replicated and streamed to the requesting client site.

From the watch state 605, the FSM can transition to either the sync state 620 or the terminated state 630, or may alternatively experience a connection failure. When a connection error is experienced by the client site while it is receiving a stream of data from the leader site, the FSM breaks out of the watch state, and as soon as the connection is reestablished, returns to the watch state 605, according to some embodiments. Also, in some embodiments, the FSM may transition to state 630 to terminate the watch (e.g., in the case of a faulty configuration).

The FSM transitions to the sync state 620, in some embodiments, when the watch has failed. For example, in some embodiments, if a client site is too far behind on its configuration, the FSM transitions to the sync state 620 to perform a one-time sync (e.g., by implementing a declarative push) and receive a full snapshot of the configuration (e.g., as described above regarding the process 200). When the sync has succeeded (e.g., “watch succeeded”), the FSM returns to the watch state 605 from the sync state 620. During the sync state 620, like during the watch state 605, the FSM can also experience a connection error or transition to terminated state 630 to terminate the sync altogether, in some embodiments.

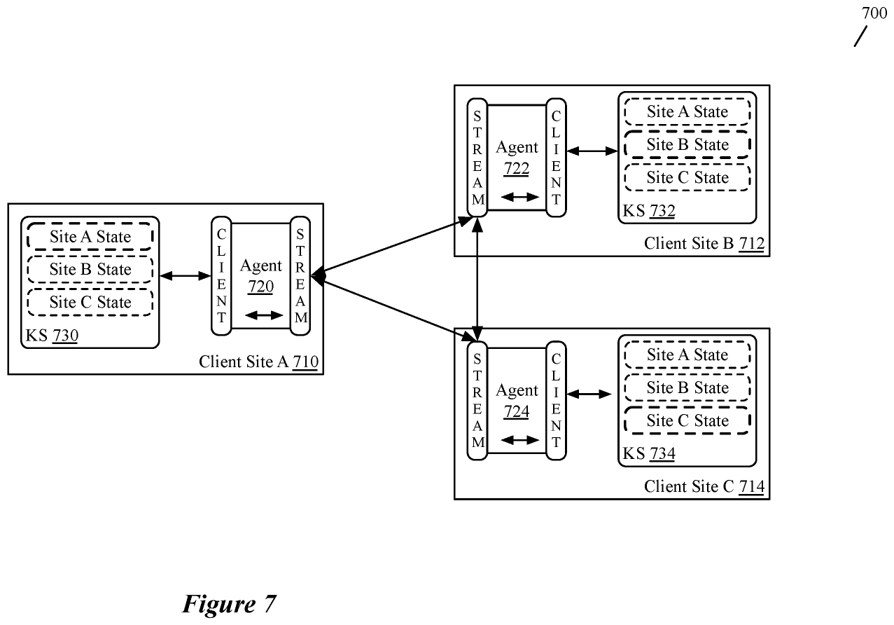

In some embodiments, each the client sites also include local site-scoped key spaces that are prefixed by the UUIDs assigned to the sites for storing per-site runtime states, or “local states” (e.g., watch, sync, terminated as described in FIG. 6). The agents at the client sites in some embodiments are configured to execute watch gRPC to get notifications when there are changes to a site-scoped local state. For example, FIG. 7 illustrates a set of client sites A-C 710-1014 in a federation 700. Each of the client sites A-C includes an agent 720-724 and a key space 730-734, as shown. Each of the key spaces 730-734 includes the states for all of the client sites A-C, with a client site's respective state appearing in bold as illustrated.

In this example, sites B and C 712-714 watch for any changes to the local state of site A 710. When a change is detected, it is persisted to their respective key spaces, according to some embodiments, thus replicating site A′s local state to sites B and C. In some embodiments, this procedure is repeated on all of the sites in order to eliminate periodic poll-based runtime state syncing. When a new site is added to the federation, such as in processes 200 and 400 described above, it invokes sync gRPC to request for a snapshot of local state from the rest of the federation and persists it locally, in some embodiments.

As mentioned above, each client site in the federation may host a DNS server for hosting a DNS application, in some embodiments. Because the DNS servers are globally distributed, it is preferable for the DNS application to be distributed as well so that all users are not having to converge on a single DNS endpoint. Accordingly, some embodiments provide a novel sharding method for performing health monitoring of resources associated with a GSLB system (i.e., a system that uses a GSLB deployment like those described above) and providing an alternate location for accessing resources in the event of failure.

The sharding method, in some embodiments, involves partitioning the responsibility for monitoring the health of different groups of resources among several DNS servers that perform DNS services for resources located at several geographically separate sites in a federation, and selecting alternate locations for accessing resources based on a client's geographic or network proximity or steering traffic to a least loaded location to avoid hot spots.

FIG. 8 illustrates an example of a GSLB system 800. As shown, the GSLB system 800 includes a set of controllers 805, several DNS service engines 810 and several groups 825 of resources 815. The DNS service engines are the DNS servers that perform DNS operations for (e.g., provide network addresses for domain names provided by) machines 820 that need to forward data message flows to the resources 815.

In some embodiments, the controller set 805 identifies several groupings 825 of the resources 815, and assigns the health monitoring of the different groups to different DNS service engines. For example, the DNS service engine 810a is assigned to check the health of the resource group 825a, the DNS service engine 810b is assigned to check the health of the resource group 825b, and the DNS service engine 810c is assigned to check the health of the resource group 825c. This association is depicted by one set of dashed lines in FIG. 8. Each of the DNS service engines 810a-810c is hosted at a respective client site (e.g., client sites 130-134), according to some embodiments. Also, in some embodiments, the data streamed between watcher agents at the leader site and respective client sites (i.e., as described above) includes configuration data relating to a DNS application hosted by the DNS service engines.

The controller set 805 in some embodiments also configures each particular DNS service engine (1) to send health monitoring messages to the particular group of resources assigned to the particular DNS service engine, (2) to generate data by analyzing responses of the resources to the health monitoring messages, and (3) to distribute the generated data to the other DNS service engines. FIG. 8 depicts with another set of dashed lines a control communication channel between the controller set 805 and the DNS service engines 810. Through this channel, the controller set configures the DNS service engines. The DNS service engines in some embodiments also provide through this channel the data that they generate based on the responses of the resources to the health monitoring messages.

In some embodiments, the resources 815 that are subjects of the health monitoring are the backend servers that process and respond to the data message flows from the machines 820. The DNS service engines 810 in some embodiments receive DNS requests from the machines 820 for at least one application executed by each of the backend servers, and in response to the DNS requests, provide network addresses to access the backend servers.

The network addresses in some embodiments include different VIP (Virtual Internet Protocol) addresses that direct the data message flows to different clusters of load balancers that distribute the load among the backend servers. Each load balancer cluster in some embodiments is in the same geographical site as the set of backend servers to which it forwards data messages. In other embodiments, the load balancers are the resources that are subject of the health monitoring. In still other embodiments, the resources that are subject to the health monitoring include both the load balancers and the backend servers.

Different embodiments use different types of health monitoring messages. Several examples of such messages are described below including ping messages, TCP messages, UDP messages, https messages, and http messages. Some of these health-monitoring messages have formats that allow the load balancers to respond, while other health-monitoring messages have formats that require the backend servers to process the messages and respond. For instance, a load balancer responds to a simple ping message, while a backend server needs to respond to an https message directed to a particular function associated with a particular domain address.

As mentioned above, each DNS service engine 810 in some embodiments is configured to analyze responses to the health monitoring messages that it sends, to generate data based on this analysis, and to distribute the generated data to the other DNS service engines. In some embodiments, the generated data is used to identify a first set of resources that have failed, and/or a second set of resources that have poor operational performance (e.g., have operational characteristics that fail to meet desired operational metrics).

In some embodiments, each particular DNS service engine 810 is configured to identify (e.g., to generate) statistics from responses that each particular resource 815 sends to the health monitoring messages from the particular DNS service engine. Each time the DNS service engine 810 generates new statistics for a particular resource, the DNS service engine in some embodiments aggregates the generated statistics with statistics it previously generated for the particular resource (e.g., by computing a weighted sum) over a duration of time. In some embodiments, each DNS service engine 810 periodically distributes to the other DNS severs the statistics it identifies for the resources that are assigned to it. Each DNS service engine 810 directly distributes the statistics that it generates to the other DNS service engines in some embodiments, while it distributes the statistics indirectly through the controller set 805 in other embodiments.

The DNS service engines in some embodiments analyze the generated and distributed statistics to assess the health of the monitored resources, and adjust the way they distribute the data message flows when they identify failed or poorly performing resources through their analysis. In some embodiments, the DNS service engines are configured similarly to analyze the same set of statistics in the same way to reach the same conclusions. Instead of distributing generated statistics regarding a set of resources, the monitoring DNS service engines in other embodiments generate health metric data from the generated statistics, and distribute the health metric data to the other DNS service engines.

FIG. 9 illustrates a more detailed example of a GSLB system 900 that uses the sharding method of some embodiments of the invention. In this example, backend application servers 905 are deployed in four datacenters 902-908, three of which are private datacenters 902-906 and one of which is a public datacenter 908. The datacenters in this example are in different geographical sites (e.g., different neighborhoods, different cities, different states, different countries, etc.). For example, the datacenters may be in any of the different client sites 130-134.

A cluster of one or more controllers 910 are deployed in each datacenter 902-908. Each datacenter also has a cluster 915 of load balancers 917 to distribute the data message load across the backend application servers 905 in the datacenter. In this example, three datacenters 902, 904 and 908 also have a cluster 920 of DNS service engines 925 to perform DNS operations to process (e.g., to provide network addresses for domain names provided by) for DNS requests submitted by machines 930 inside or outside of the datacenters. In some embodiments, the DNS requests include requests for fully qualified domain name (FQDN) address resolutions.

FIG. 9 illustrates the resolution of an FQDN that refers to a particular application “A” that is executed by the servers of the domain acme.com. As shown, this application is accessed through https and the URL “A.acme.com”. The DNS request for this application is resolved in three steps. First, a public DNS resolver 960 initially receives the DNS request and forwards this request to the private DNS resolver 965 of the enterprise that owns or manages the private datacenters 902-906.

Second, the private DNS resolver 965 selects one of the DNS clusters 920. This selection is random in some embodiments, while in other embodiments it is based on a set of load balancing criteria that distributes the DNS request load across the DNS clusters 920. In the example illustrated in FIG. 9, the private DNS resolver 965 selects the DNS cluster 920b of the datacenter 904.

Third, the selected DNS cluster 920b resolves the domain name to an IP address. In some embodiments, each DNS cluster includes multiple DNS service engines 925, such as DNS service virtual machines (SVMs) that execute on host computers in the cluster's datacenter. When a DNS cluster 920 receives a DNS request, a frontend load balancer (not shown) in some embodiments selects a DNS service engine 925 in the cluster to respond to the DNS request, and forwards the DNS request to the selected DNS service engine. Other embodiments do not use a frontend load balancer, and instead have a DNS service engine serve as a frontend load balancer that selects itself or another DNS service engine in the same cluster for processing the DNS request.

The DNS service engine 925b that processes the DNS request then uses a set of criteria to select one of the backend server clusters 905 for processing data message flows from the machine 930 that sent the DNS request. The set of criteria for this selection in some embodiments (1) includes the health metrics that are generated from the health monitoring that the DNS service engines perform, or (2) is generated from these health metrics, as further described below. Also, in some embodiments, the set of criteria include load balancing criteria that the DNS service engines use to distribute the data message load on backend servers that execute application “A.”

In the example illustrated in FIG. 9, the selected backend server cluster is the server cluster 905c in the private datacenter 906. After selecting this backend server cluster 905c for the DNS request that it receives, the DNS service engine 925b of the DNS cluster 920b returns a response to the requesting machine. As shown, this response includes the VIP address associated with the selected backend server cluster 905. In some embodiments, this VIP address is associated with the local load balancer cluster 915c that is in the same datacenter 906 as the selected backend server cluster.

After getting the VIP address, the machine 930 sends one or more data message flows to the VIP address for a backend server cluster 905 to process. In this example, the data message flows are received by the local load balancer cluster 915c. In some embodiments, each load balancer cluster 915 has multiple load balancing engines 917 (e.g., load balancing SVMs) that execute on host computers in the cluster's datacenter.

When the load balancer cluster receives the first data message of the flow, a frontend load balancer (not shown) in some embodiments selects a load balancing service engine 917 in the cluster to select a backend server 905 to receive the data message flow, and forwards the data message to the selected load balancing service engine. Other embodiments do not use a frontend load balancer, and instead have a load balancing service engine in the cluster serve as a frontend load balancer that selects itself or another load balancing service engine in the same cluster for processing the received data message flow.

When a selected load balancing service engine 917 processes the first data message of the flow, this service engine uses a set of load balancing criteria (e.g., a set of weight values) to select one backend server from the cluster of backend servers 905c in the same datacenter 906. The load balancing service engine then replaces the VIP address with an actual destination IP (DIP) address of the selected backend server, and forwards the data message and subsequent data messages of the same flow to the selected back end server. The selected backend server then processes the data message flow, and when necessary, sends a responsive data message flow to the machine 930. In some embodiments, the responsive data message flow is through the load balancing service engine that selected the backend server for the initial data message flow from the machine 930.

Like the controllers 805, the controllers 910 facilitate the health-monitoring method that the GSLB system 900 performs in some embodiments, as well as define groups of load balancers 917 and/or backend servers 905 to monitor, to assign the different groups to different DNS service engines 925, and to configure these servers and/or clusters to perform the health monitoring.

In some embodiments, the controllers 910 generate and update a hash wheel (not shown) that associates different DNS service engines 925 with different load balancers 917 and/or backend servers 905 to monitor. The hash wheel in some embodiments has several different ranges of hash values, with each range associated with a different DNS service engines. In some embodiments, the controllers 910 provide each DNS service engine with a copy of this hash wheel, and a hash generator (e.g., a hash function; also not shown) that generates a hash value from different identifiers of different resources that are to be monitored. For each resource, each DNS service engine in some embodiments (1) uses the hash generator to generate a hash value from the resource's identifier, (2) identifies the hash range that contains the generated hash value, (3) identifies the DNS service engine associated with the identified hash range, and (4) adds the resource to its list of resources to monitor when it is the identified DNS service engine identified by the hash wheel for the resource.

In some embodiments, the controllers 910 assign the different resources (e.g., load balancers 917 and/or backend servers 925) to the different DNS clusters 920, and have each cluster determine how to distribute the health monitoring load among its own DNS service engines. Still other embodiments use other techniques to shard the health monitoring responsibility among the different DNS service engines 925 and clusters 920.

In some embodiments, the controllers 910 also collect health-monitoring data that their respective DNS service engines 925 (e.g., the DNS service engines in the same datacenters as the controllers) generate, and distribute the health-monitoring data to other DNS service engines 925. In some embodiments, a first controller in a first datacenter distributes health-monitoring data to a set of DNS service engines in a second datacenter by providing this data to a second controller in the second datacenter to forward the data to the set of DNS service engines in the second datacenter. Even though FIG. 9 and its accompanying discussion refer to just one controller in each datacenter 902-908, one of ordinary skill will realize that in some embodiments a cluster of two or more controllers are used in each datacenter 902-908.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

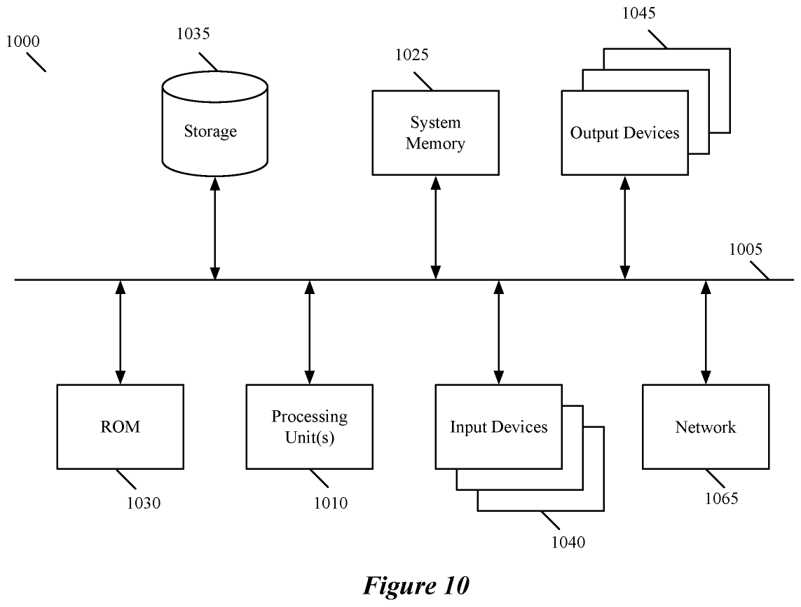

FIG. 10 conceptually illustrates a computer system 1000 with which some embodiments of the invention are implemented. The computer system 1000 can be used to implement any of the above-described hosts, controllers, gateway and edge forwarding elements. As such, it can be used to execute any of the above described processes. This computer system includes various types of non-transitory machine readable media and interfaces for various other types of machine readable media. Computer system 1000 includes a bus 1005, processing unit(s) 1010, a system memory 1025, a read-only memory 1030, a permanent storage device 1035, input devices 1040, and output devices 1045.

The bus 1005 collectively represents all system, peripheral, and chipset buses that communicatively connect the numerous internal devices of the computer system 1000. For instance, the bus 1005 communicatively connects the processing unit(s) 1010 with the read-only memory 1030, the system memory 1025, and the permanent storage device 1035.

From these various memory units, the processing unit(s) 1010 retrieve instructions to execute and data to process in order to execute the processes of the invention. The processing unit(s) may be a single processor or a multi-core processor in different embodiments. The read-only-memory (ROM) 1030 stores static data and instructions that are needed by the processing unit(s) 1010 and other modules of the computer system. The permanent storage device 1035, on the other hand, is a read-and-write memory device. This device is a non-volatile memory unit that stores instructions and data even when the computer system 1000 is off. Some embodiments of the invention use a mass-storage device (such as a magnetic or optical disk and its corresponding disk drive) as the permanent storage device 1035.

Other embodiments use a removable storage device (such as a floppy disk, flash drive, etc.) as the permanent storage device. Like the permanent storage device 1035, the system memory 1025 is a read-and-write memory device. However, unlike storage device 1035, the system memory is a volatile read-and-write memory, such as random access memory. The system memory stores some of the instructions and data that the processor needs at runtime. In some embodiments, the invention's processes are stored in the system memory 1025, the permanent storage device 1035, and/or the read-only memory 1030. From these various memory units, the processing unit(s) 1010 retrieve instructions to execute and data to process in order to execute the processes of some embodiments.

The bus 1005 also connects to the input and output devices 1040 and 1045. The input devices enable the user to communicate information and select commands to the computer system. The input devices 1040 include alphanumeric keyboards and pointing devices (also called “cursor control devices”). The output devices 1045 display images generated by the computer system. The output devices include printers and display devices, such as cathode ray tubes (CRT) or liquid crystal displays (LCD). Some embodiments include devices such as touchscreens that function as both input and output devices.

Finally, as shown in FIG. 10, bus 1005 also couples computer system 1000 to a network 1065 through a network adapter (not shown). In this manner, the computer can be a part of a network of computers (such as a local area network (“LAN”), a wide area network (“WAN”), or an Intranet), or a network of networks (such as the Internet). Any or all components of computer system 1000 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra-density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms “display” or “displaying” mean displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A method of providing resiliency for globally distributed applications that span a federation comprising a plurality of geographically dispersed sites, the method comprising:
at a first site in the plurality of sites,
receiving, from a second site in the plurality of sites, a login request for accessing a federated datastore maintained at the first site;
determining that the second site should be authorized and providing an authorization token to the second site, wherein the authorization token identifies the second site as an authorized site; and
based on the authorization token, replicating a set of data from the federated datastore to the second site.

2. The method of claim 1 further comprising receiving a confirmation notification from the second site indicating that the second site has consumed the replicated set of data.

3. The method of claim 1 further comprising:
detecting a connection error with the second site;
waiting for the connection error to resolve;
upon detecting that the second site has reconnected, determining a subset of data from the replicated set of data has not been consumed by the second site; and
streaming the subset of data to the second site.

4. The method of claim 1, wherein the first site is a leader first site and the second site is a client second site in a plurality of client sites.

5. The method of claim 4, wherein
each client site in the plurality of client sites comprises a watcher agent and an API server; and
the leader first site comprises a plurality of watcher agents that each correspond to a watcher agent at a respective client site.

6. The method of claim 5, wherein the plurality of watcher agents at the leader first site maintain connectivity with the federated datastore to extend capabilities of the federated datastore across the federation.

7. The method of claim 6, wherein
the plurality of watcher agents at the leader site monitor the federated datastore for updates, and
each client site watcher agent watches for updates from a corresponding leader site watcher agent.

8. The method of claim 7, wherein upon detecting an update to the federated datastore, the plurality of leader site watcher agents automatically replicate and stream the update to each respective client site watcher agents at the plurality of client sites.

9. The method of claim 8 further comprising:
at a particular watcher agent at a particular client site,
receiving the update; and
interfacing with a particular API server at the particular client site, wherein the particular API agent propagates the update to a particular database at the client site.

10. The method of claim 7, wherein a proxy engine at the leader site enables the plurality of watcher agents at the leader site to use bidirectional gRPC streaming to share data with each respective client site watcher agent.

11. The method of claim 4 further comprising receiving, through a user interface (UI), a set of input that causes the leader site to stream a subset of objects to the plurality of client sites.

12. The method of claim 3, wherein the connection error is one of a service interruption, a network partition, and a connection loss due to scheduled maintenance.

13. The method of claim 8, wherein a particular client site is determined to be in a suspended mode and unavailable to receive updates, the method further comprising terminating a particular watcher agent at the leader site that is associated with the particular client site.

14. The method of claim 1, wherein the federated datastore is built on an efficient version-based object storage mechanism.

15. The method of claim 14, wherein the federated datastore maintains a latest version of a configuration for the federation in-memory.

16. The method of claim 15, wherein the federated datastore uses a set of diff queues to reconstruct older versions of the configuration in response to requests for older versions, wherein if a requested version is older than a minimum version in any particular diff queue the request is rejected.

17. The method of claim 1, wherein the set of data comprises a full snapshot of a configuration of the federation.

18. The method of claim 1, wherein the set of data comprises a portion of a configuration of the federation.

19. The method of claim 4, wherein each client site in the plurality of client sites hosts a domain name system (DNS) server for implementing a globally distributed DNS application.
